(19) United States
(12) Patent Application Publication
(10) Pub. No.: US 2024/0097814 A1
(43) Pub. Date: Mar. 21, 2024

(54) OPTIMAL MODULATION CODING SCHEME (MCS) PARAMETERS FOR WIRELESS

(71) Applicant: Cisco Technology, Inc., San Jose, CA (US)

(72) Inventors: Pascal Thubert, Roquefort-les-Pins (FR); Domenico Ficara, Essertines-sur-Yverdon,Vaud (CH); Amine Choukir, Lausanne,Vaud (CH); Jerome Henry, Pittsboro, NC (US); Arun G. Khanna, Sunnyvale, CA (US)

(73) Assignee: Cisco Technology, Inc., San Jose, CA (US)

(21) Appl. No.: 17/933,112

(22) Filed: Sep. 18, 2022

(51) Int. Cl. H04L 1/00

(52) U.S. Cl. CPC H04L 1/0003; H04L 1/0009

(57) ABSTRACT

Optimal coding scheme parameters may be provided. Information associated with a plurality of client devices may be received by a computing device. A map of locations of the plurality of client devices relative to an Access Point (AP) may be created based on the information. A connected dominating set of client devices within the plurality of client devices may be identified based on the map. A first client device in the connected dominating set may then be caused to relay data between the AP and a second client device comprising a client device in the plurality of client devices that is dominated by the first client device in the connected dominating set.

### TECHNICAL FIELD

The present disclosure relates generally to optimal Modulation Coding Scheme (MCS) parameters.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing optimal coding scheme parameters;

FIG. 2 is a block diagram of an operating environment for providing optimal coding scheme parameters;

FIG. 3 is a flow chart of a method for providing optimal coding scheme parameters; and

FIG. 4 is a block diagram of a computing device.

### DETAILED DESCRIPTION

### Overview

Optimal coding scheme parameters may be provided. Information associated with a plurality of client devices may be received by a computing device. A map of locations of the plurality of client devices relative to an Access Point (AP) may be created based on the information. A connected dominating set of client devices within the plurality of client devices may be identified based on the map. A first client device in the connected dominating set may then be caused to relay data between the AP and a second client device comprising a client device in the plurality of client devices that is dominated by the first client device in the connected dominating set.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Electrical and Electronics Engineers (IEEE) 802.11 standard, multicast/broadcast traffic may be sent at the lowest possible coding scheme rate to make sure that all stations (e.g., client devices) may correctly receive the traffic. This may consume a large amount of airtime for the same traffic, which may be problematic for latency-sensitive applications and may forgo the broadcast nature of the wireless medium.

The Modulation Coding Scheme (MCS) index may comprise an existing industry metric based on several parameters of a Wi-Fi connection between a client device and a wireless access point, including data rate, channel width, and the number of antennas or spatial streams in the device. Rather than transmit at the lowest possible coding scheme (e.g., an MCS coding scheme), embodiments of the disclosure may identify a connected dominating set among connected client devices whose connection to an AP may have good physical properties, and accordingly a best coding scheme (e.g. a best Modulation Coding Scheme (MCS) index) may be used. The connected dominating set member may relay the broadcast to far client devices allowing the use of a faster rate (i.e., a faster MCS index). Duplicates from repeats by the dominating set member may be eliminated, but may constitute a second chance to receive the broadcast.

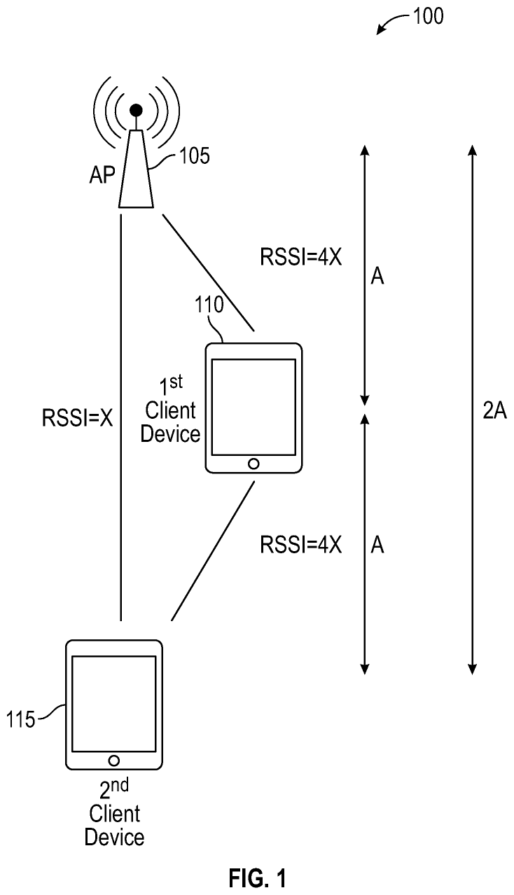

FIG. 1 is a block diagram of an operating environment for providing optimal coding scheme parameters. As shown in FIG. 1, the operating environment may comprise an AP 105, a first client device 110, and a second client device 115. In order to illustrate an improvement on airtime utilization and provide a better MCS/Phy rate, the following may be considered: i) radio signal power attenuates with the square of the distance from the emitter; and ii) the capacity of a channel may be proportional to the Signal to Noise Ratio (SNR), where large bandwidth is available (e.g., in IEEE 802.11) in a power-limited-regime. Accordingly, if the connection from AP 105 to some far client device (e.g. second client device 115) is separated in two legs, with a relay in the middle (e.g. first client device 110), the channel capacity of each leg (as per information theory) may be 4 times that of the direct channel, hence transmitting the same message may take ¼ of the time in each of the legs.

In other words, even if relaying the frame via the relay in the middle (e.g. first client device 110) costs 2 time slots (i.e., because of the need to traverse two legs), there may still be an advantage in relaying the frame because 2 times one-fourth of the direct-connection time may be spent (i.e., 2×¼=½). This an example and the actual advantage may depend on the gap between the coding scheme rate (e.g., the MCS coding scheme rate) that may be used for broadcast/multicast communication over the entire Basic Service Set (BSS) versus the coding scheme rate (e.g., the MCS coding scheme rate) usable over the two legged communication, which may ultimately result in better than a 2× improvement.

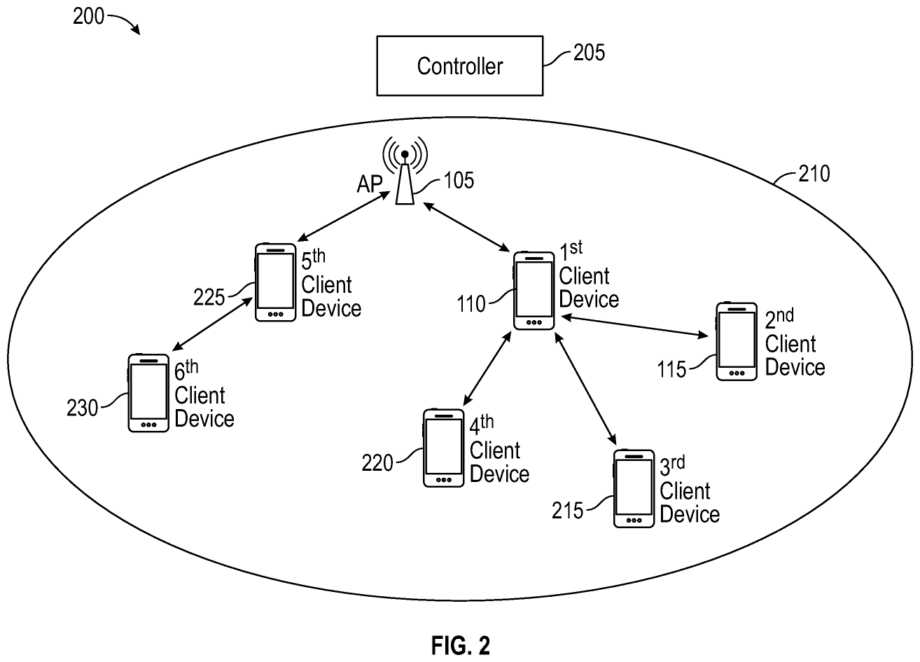

FIG. 2 shows an operating environment 200 for providing optimal coding scheme parameters. As shown in FIG. 2, operating environment 200 may comprise a controller 205 and a coverage environment 210. Coverage environment 210 may comprise, but is not limited to, a Wireless Local Area Network (WLAN) comprising a plurality of Access Points (APs) that may provide wireless network access (e.g., access to the WLAN for client devices). The plurality of APs may include, but are not limited to, AP 105 in addition to other APs. The plurality of APs may provide wireless network access to a plurality of client devices as they move within coverage environment 210.

The plurality of client devices may comprise, but are not limited to, first client device 110, second client device 115, a third client device 215, a fourth client device 220, a fifth client device 225, and a sixth client device 230. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs and the plurality of client devices may be compatible with specification standards such as, but not limited to, the IEEE 802.11 ax/be specification standard for example.

Controller 205 may comprise a Wireless Local Area Network Controller (WLC) and may provision and control coverage environment 210 (e.g., a WLAN). Controller 205 may allow first client device 110, second client device 115, third client device 215, fourth client device 220, fifth client device 225, and sixth client device 230 to join coverage environment 210. In some embodiments of the disclosure, controller 205 may be implemented by a Digital Network Architecture Center (DNAC) controller (i.e., a Software-Defined Network (SDN) controller) that may configure information for coverage environment 210 in order to provide optimal coding scheme parameters.

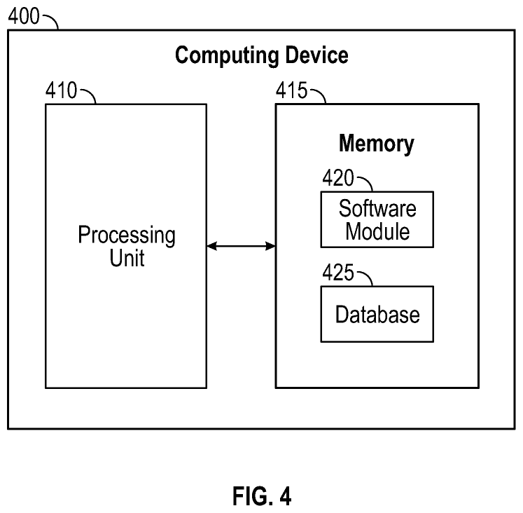

The elements described above of operating environment 100 (e.g., controller 205, AP 105, first client device 110, second client device 115, third client device 215, fourth client device 220, fifth client device 225, and sixth client device 230) may be practiced in hardware and/or in software (including firmware, resident software, micro-code, etc.) or in any other circuits or systems. The elements of operating environment 200 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 200 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 200 may be practiced in a computing device 400.

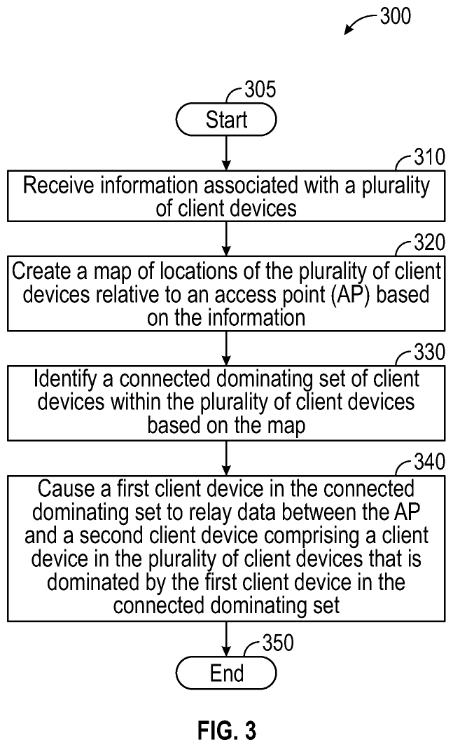

FIG. 3 is a flow chart setting forth the general stages involved in a method 300 consistent with embodiments of the disclosure for providing optimal coding scheme parameters. Method 300 may be implemented using a computing device 400 as described in more detail below with respect to FIG. 4. Computing device 400 may be disposed in AP 105 or controller 205 for example. Ways to implement the stages of method 300 will be described in greater detail below.

Method 300 may begin at starting block 305 and proceed to stage 310 where computing device 400 may receive information associated with a plurality of client devices. For example, the plurality of client devices may comprise, but are not limited to, first client device 110, second client device 115, third client device 215, fourth client device 220, fifth client device 225, and sixth client device 230. Each of the plurality of client devices may report to AP 105: i) which of the other client devices it can see; and ii) at what strength (e.g., Received Signal Strength Indicator (RSSI) levels it sees other client devices at). This may comprise the information associated with the plurality of client devices that AP 105 receives. An example of this information may comprise, but is not limited to, IEEE 802.11 Neighbor Reports.

From stage 310, where computing device 400 receives information associated with the plurality of client devices, method 300 may advance to stage 320 where computing device 400 may create a map of locations of the plurality of client devices relative to AP 105 based on the information. For example, based on the knowledge of which client devices can see which other client devices and the signal level (e.g., RSSI) at which they see other client devices, along with which client devices AP 105 sees and at what signal level (e.g., RSSI), computing device 400 may create a map of locations of the plurality of client devices relative to AP 105.

Once computing device 400 creates the map of locations of the plurality of client devices relative to AP 105 based on the information in stage 320, method 300 may continue to stage 330 where computing device 400 may identify a connected dominating set of client devices within the plurality of client devices based on the map. For example, a connected dominating set of a graph G may comprise a set D of vertices with two properties: i) any node in D may reach any other node in D by a path that stays entirely within D; and ii) every vertex in G either belongs to D or is adjacent to a vertex in D. In other words, D may comprise a dominating set of G. A minimum connected dominating set of a graph G may comprise a connected dominating set with the smallest possible cardinality among all connected dominating sets of G. In the example shown in FIG. 2, nodes may comprise client devices.

As illustrated by FIG. 2, first client device 110 may see second client device 115, third client device 215, and fourth client device 220 at different signal levels, but it may not see fifth client device 225 or sixth client device 230. Second client device 115, third client device 215, and fourth client device 220 may or may not see each other. AP 105 may see first client device 110, second client device 115, third client device 215, and fourth client device 220, but may see first client device 110 as having the highest signal strength. Consequently, computing device 400 may determine that first client device 110 may dominate second client device 115, third client device 215, and fourth client device 220.

As further illustrated by FIG. 2, fifth client device 225 may see sixth client device 230, but not first client device 110, second client device 115, third client device 215, or fourth client device 220. AP 105 may see fifth client device 225 and sixth client device 230, but may see fifth client device 225 as having a higher signal strength than sixth client device 230. Consequently, computing device 400 may determine that fifth client device 225 may dominate sixth client device 230. Accordingly, first client device 110 and fifth client device 225 may comprise the connected dominating set of client devices within the plurality of client devices. Furthermore, first client device 110 and fifth client device 225 may comprise the minimum connected dominating set.

After computing device 400 identifies the connected dominating set of client devices within the plurality of client devices based on the map in stage 330, method 300 may proceed to stage 340 where computing device 400 may cause first client device 110 in the connected dominating set to relay data between AP 105 and second client device 115 comprising a client device in the plurality of client devices that is dominated by first client device 110 in the connected dominating set. For example, AP 105 may identify a connected dominating set (e.g., first client device 110 and fifth client device 225). The connected dominating set's connections to AP 105 may have very good physical properties and hence may be able to support a higher MCS index than may be possible with any other of the plurality of client devices. Computing device 400 may signal to the connected dominating set (e.g., first client device 110 and fifth client device 225) that they are to act as relays consistent with embodiments of the disclosure.

AP 105 may send any broadcast frames to the client devices in the connected dominating set. The connected dominating set may not have to be a minimum connected dominating set because the connected dominating set may be client devices at a certain range, in which case only some of them have a non-empty dominated set and AP 105 may use a broadcast at a faster MCS rate to reach the dominating set. Embodiment of the disclosure may select a close to minimum connected dominating and when that connected dominating set is of a small size, unicast may be used to reach the connected dominating set members more reliably and faster.

The client devices in the connected dominating set may, in turn, relay the frame to their dominated set (i.e., client devices that they dominate that may be farther away from AP 105, but closer to the connected dominating set). The connected dominating set members may act as a form of relay nodes. Again, depending on the size of the connected dominated set, the connected dominating set nodes may resort to either a broadcast or a series of unicast. Transmissions between AP 105 and the connected dominating set may use the best MCS indexes supported by their present conditions. Similarly, transmissions between the connected dominating set and the client devices that they dominate may use the best MCS indexes support by their present conditions. Once computing device 400 causes first client device 110 in the connected dominating set to relay data between AP 105 and second client device 115 comprising the client device in the plurality of client devices that is dominated by first client device 110 in the connected dominating set in stage 340, method 300 may then end at stage 350.

Embodiments of the disclosure may support collision avoidance. For example, the relay nodes (e.g., client devices in the connected dominating set) may have to transmit a frame in the final leg at the same time. This may potentially create a second problem of collisions (e.g., happening in the same frequency channel). When AP 105 sends a frame to the connected dominating set, AP 105 may need to let the connected dominating set repeat before AP 105 sends the next frame. Otherwise the connected dominating set members may miss the next frame because they may be relaying the frame to the client devices that they dominate. In some cases, AP 105 may leave blanks in the transmission to allow the connected dominating set members to repeat, but this may create a waste of resources.

AP 105 may need to determine an MCS index for repeating to the repeating connected dominating set member, and determine how long that member may be transmitting. Consistent with embodiments of the disclosure, connected dominating set members may signal to AP 105 the MCS they may use to relay the frame to the client devices that they dominate. Accordingly, AP 105 may then optimize its transmission to the connected dominating set members by taking into account the time it takes for the connected dominating set members to relay the frame to the client devices that they dominate based upon the MCS index the connected dominating set may use to relay the frame to the client devices that they dominate.

Consistent with embodiments of the disclosure, AP 105 may distribute the bursts of broadcasts over time to avoid having to send multiple broadcasts in a row. AP 105 may send the next unicast to a node that does not repeat the previous multicast. This way the repeat of the previous multicast by the connected dominating set member and the next unicast by AP 105 may happen at the same time. To achieve this, AP 105 and the connected dominating set members may ignore that they appear to collide, though they do not really because the final destination of the repeated signal may be far from AP 105 and may ignore the signal from AP 105.

When doing a real multicast, AP 105 may select different connected dominating sets (e.g., no common members) for different groups. Then AP 105 may alternate the transmissions to the groups by interleaving the bursts, so that a connected dominating set may never send two frames in a row and has time to forward.

For collision between the repeated frames, embodiments of the disclosure may discriminate through different BSS coloring. Each client device in the connected dominating set may use a different color, thus avoiding collisions. For example, first client device 110 may use BSS color=“X” when communicating with second client device 115, third client device 215, and fourth client device 220. Fifth client device 225 may use BSS color=“Y” when communicating with sixth client device 230.

Consistent with embodiments of the disclosure, beacon frames may be relayed, thus improving on beacon cost on airtime. In the case where beacon protection is used (e.g., Wi-Fi Protected Access 3 (WPA3)), the BSS color may have to be stripped from the message at the receiver to authenticate the beacon. This may be extended to other management frames as well.

When a frame is sent in unicast by AP 105 to a connected dominating set member, and the dominating client device (e.g., first client device 110) uses a series of unicast to reach its dominated set (e.g., second client device 115, third client device 215, and fourth client device 220), it may be the responsibility of AP 105 to ensure that all the members of the multicast group (or all associated nodes for a broadcast) may be reached. In this case, with embodiments of the disclosure, AP 105 may add a list of destination Media Access Control (MAC) addresses of its dominated set in the unicast copy to the connected dominating set members. This may be a source-routed multicast. The MCS parameters that AP 105 expects the dominating set members to use may also be indicated. This may be used for real multicast (e.g., based on Multicast Listener Discovery (MLD) snooping). In this case, AP 105 may form a 2-hop tree per destination multicast address, either found in the Layer-2 (L2) or Layer-3 (L3) destination address field.

By using a high-rate MCS index at the first leg of the transmission, AP 105 may make it rare for far client devices to decode the frame, hence avoiding most cases of duplicated-frame problems because these far client devices may receive the frame at the second step from the relay nodes.

When the frame is sent unicast by AP 105 to the connected dominating set members, and the connected dominating set members use a broadcast to reach its dominated set, or when AP 105 uses a broadcast to reach the connected dominating set members, there may still be a risk that a dominated client device may receive more than one copy of a frame. Duplicate elimination processes may be used at the client device to drop the extra frame copy. This repetition may provide a second chance for a client device that missed the initial copy while in range of the AP 105 to receive the broadcast anyway.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing optimal coding scheme parameters as described above with respect to FIG. 3. Computing device 400, for example, may provide an operating environment for controller 205, AP 105, first client device 110, second client device 115, third client device 215, fourth client device 220, fifth client device 225, and sixth client device 230. Controller 205, AP 105, first client device 110, second client device 115, third client device 215, fourth client device 220, fifth client device 225, and sixth client device 230 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay devices, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 2 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by a computing device, information associated with a plurality of client devices;
creating a map of locations of the plurality of client devices relative to an Access Point (AP) based on the information;
identifying a connected dominating set of client devices within the plurality of client devices based on the map; and
causing a first client device in the connected dominating set to relay data between the AP and a second client device comprising a client device in the plurality of client devices that is dominated by the first client device in the connected dominating set.

2. The method of claim 1, wherein the AP and the first client device communicate via unicast.

3. The method of claim 1, wherein the AP and the first client device communicate via broadcast.

4. The method of claim 1, wherein the first client device and the second client device communicate via unicast.

5. The method of claim 1, wherein the first client device and the second client device communicate via broadcast.

6. The method of claim 1, wherein a best Modulation Coding Scheme (MCS) is used between the AP and the first client device.

7. The method of claim 1, wherein a best Modulation Coding Scheme (MCS) is used between the first client device and the second client device.

8. The method of claim 1, wherein the connected dominating set comprises a minimum connected dominating set.

9. The method of claim 1, further comprising:
receiving, by the computing device, a Modulation Coding Scheme (MCS) used between the first client device and the second client device; and
determining a time between sending frames from the AP to the first client device based on the MCS used between the first client device and the second client device.

10. The method of claim 1, wherein the first client device in the connected dominating set uses a different Basic Service Set (BSS) color than other client devices in the connected dominating set.

11. The method of claim 1, wherein the data comprises beacons.

12. The method of claim 1, further comprising sending, by the AP and the first client device, packets at a same time to avoid collision.

13. A system comprising:
a memory storage; and
a processing unit coupled to the memory storage, wherein the processing unit is operative to:
receive information associated with a plurality of client devices;
create a map of locations of the plurality of client devices relative to an Access Point (AP) based on the information;
identify a connected dominating set of client devices within the plurality of client devices based on the map; and
cause a first client device in the connected dominating set to relay data between the AP and a second client device comprising a client device in the plurality of client devices that is dominated by the first client device in the connected dominating set.

14. The system of claim 13, wherein the processing unit is further operative to:
receive a Modulation Coding Scheme (MCS) used between the first client device and the second client device; and
determine a time between sending frames from the AP to the first client device based on the MCS used between the first client device and the second client device.

15. The system of claim 13, wherein a best Modulation Coding Scheme (MCS) is used between the AP and the first client device.

16. The system of claim 13, wherein the data comprises beacons.

17. A computer-readable medium that stores a set of instructions which when executed perform a method, the method executed by the set of instructions comprising:
receiving, by a computing device, information associated with a plurality of client devices;
creating a map of locations of the plurality of client devices relative to an Access Point (AP) based on the information;
identifying a connected dominating set of client devices within the plurality of client devices based on the map; and
causing a first client device in the connected dominating set to relay data between the AP and a second client device comprising a client device in the plurality of client devices that is dominated by the first client device in the connected dominating set.

18. The computer-readable medium of claim 17, wherein the connected dominating set comprises a minimum connected dominating set.

19. The computer-readable medium of claim 17, further comprising:
receiving, by the computing device, a Modulation Coding Scheme (MCS) used between the first client device and the second client device; and
determining a time between sending frames from the AP to the first client device based on the MCS used between the first client device and the second client device.

20. The computer-readable medium of claim 17, wherein the first client device in the connected dominating set uses a different Basic Service Set (BSS) color than other client devices in the connected dominating set.
